(19) United States
(12) Patent Application Publication
(10) Pub. No.: US 2015/0221409 A1
(43) Pub. Date: Aug. 6, 2015

(54) Graphene Composite Fiber and Method for Manufacturing the Same

(71) Applicant: Enerage Inc., Yilan County (TW)

(72) Inventors: Mark Y. WU, Yilan County (TW); Cheng-Yu HSIEH, Yilan County (TW); Jing-Ru CHEN, Yilan County (TW); Shu-Ling HSIEH, Yilan County (TW)

(21) Appl. No.: 14/305,862

(22) Filed: Jun. 16, 2014

(30) Foreign Application Priority Data
Feb. 5, 2014 (TW) 103103791

(51) Int. Cl. H01B 1/12; D01F 1/09; D01D 5/08

(52) U.S. Cl. CPC H01B 1/12; D01D 5/08; D01F 1/09

(57) ABSTRACT

Disclosed is a graphene composite fiber and a method for manufacturing the same. The graphene composite fiber includes a polymer material and graphene sheets which are 1˜10% by weight of the graphene composite fiber, each having a modified layer with first organic functional groups and second organic functional groups for forming chemical bonds with the surface of the graphene sheet and the polymer material, respectively. The polymer material is a thermoplastic polymer for enclosing the graphene sheets. The method includes steps of preparing graphene sheets, modifying the surfaces of the graphene sheets, adding melted polymer material, blending, forming composite raw particles through the granulator, and finally spinning to form the graphene composite fibers. The graphene composite fibers of the present invention are manufactured by simple processes and possess excellent mechanical strength, thermal conductivity and electrical conductivity, thereby replacing commonly used fibers.

### CROSS-REFERENCE TO RELATED APPLICATION

This application claims the priority of Taiwanese patent application No. 103103791, filed on Feb. 5, 2014, which is incorporated herewith by reference.

### BACKGROUND OF THE INVENTION

1. Field of the Invention

The present invention generally relates to a graphene composite fiber and a method for manufacturing the same, and more specifically to a graphene composite fiber comprising graphene sheets and a polymer material, and a method for manufacturing the same.

2. The Prior Arts

With light, high mechanical strength and excellent elastic modulus, carbon fiber has attracted many current markets, especially race bike such as Le Tour de France. Recently, carbon fiber has become the most popular material and greatly replaced traditional Magnesium-Aluminum (Mg—Al) alloy in the application field of bicycle. Besides, carbon fiber has been successfully and widely applied to various industries like aircraft, aerospace, national defense, automobile and energy because of its chemical inertia and semiconductor properties. EP 1,696,046 B1 disclosed a method for producing a metal-based carbon fiber composite material. Specifically, the sintering means by use of pulse electric current is applied to metal powder and carbon fiber aligned in a specific manner so as to form the composite material. Such a material has high thermal conductivity and can effectively control the heat flow. Thus, many heat dissipation mechanisms are implemented by carbon fiber and applied to electronic equipments, host servers, or power supply modules.

Further, US 2013/0084455 A1 disclosed methods for the preparation of carbon fiber from polyolefin fiber precursor, and carbon fibers made thereby. The polyolefin fiber precursor is partially sulfonated and then carbonized to produce carbon fiber. It is thus easy to control the shape, look and properties of carbon fiber by adjusting the degree of sulfonation.

In addition to carbon fiber, some present carbon materials with outstanding performance are also gradually noted and potentially replace carbon fiber, including Vapor Grown Carbon Fiber (VGCF), thermal-carbonation carbon fiber made of polyacrylonitrile, and graphite fiber. However, among so many carbon materials, graphene generated from the graphite material by decomposition is particularly noted by the mechanical applications because graphene has a thickness of only one carbon atom diameter, about 0.335 nm, and possesses an excellent mechanical strength higher than that of steel by hundred times more, especially its density only one fourth of that of steel. The graphene is generally formed of a two-dimensional crystalline structure, which is constructed by hexagonal honeycombs bound by sp2 hybrid orbital. Specifically, graphene has an electrical resistivity lower than that of copper and silver, its electron mobility is pretty higher, and especially almost transparent such that extreme attention is drawn for the field of photoelectrical applications.

US 2012/0298396 A1 disclosed graphene fiber, method for manufacturing same and use thereof. Specifically, this patent employs Chemical Vapor Deposition (CVD) to deposit the graphene on electrical pattern provided on the metal substrate, and finally immerses the substrate in an etching solution to etch the electrical pattern so as to leave graphene fiber. This method has some inevitable shortcomings. First, the deposit rate in CVD is very slow, and the reactant gases are poisonous, leading to a risky working environment. Besides, a large amount of waste acid is generated, even unfriendly to the environment.

Furthermore, WO 2012/124937 A2 disclosed “GRAPHENE CONJUGATE FIBER AND METHOD FOR MANUFACTURING SAME”. The gaphene fiber manufactured is formed the polymer and the graphene flakes twisted together. The method comprises adding a surfactant to help well mix graphene dispersed in a solvent to prepare a dispersion, then wet spinning the resulting solution to form the fiber, dipping the fiber in methanol or acetone to improve the degree of crystallization of the fiber, and finally drying the fiber to obtain the graphene composite fiber with high mechanical strength. In CN 102586916 A, a method is performed by adding a polymer material into a graphite oxide solution, injecting nitrogen gas, heating up to invoke thermal reaction to prepare graphene powder of branched polymer, adding a solvent to well mix to form a spinning slurry, and finally extruding the spinning slurry into a condensation bath to obtain the graphene composite fiber.

However, all the above prior arts need chemicals to help dissolve or increase the degree of crystallization of the fiber. Additionally, the current traditional equipments for manufacturing carbon fiber are not available. Even if the graphene fiber with excellent properties is manufactured, the manufacturing cost is pretty high and more additional equipments are needed. As a result, the graphene composite fiber in the prior arts still fails to cut in the ready market. Therefore, it is greatly desired to provide a simple method similar to traditional weaving processes for directly manufacturing graphene composite fiber by use of current equipments to overcome the above problems in the prior arts.

### SUMMARY OF THE INVENTION

The primary object of the present invention is to provide a graphene composite fiber, which comprises a plurality of graphene sheets and a polymer material. The graphene sheets are 1˜10% by weight of the graphene composite fiber. Specifically, each graphene sheet is formed of N graphene layers stacked, wherein N is one integer larger than 1 and less than 1,000. The graphene sheet comprises at least one modified layer on the surface of the graphene sheet, and the modified layer comprises first organic functional groups for forming chemical bonds with the graphene layers, and second organic functional groups for forming chemical bonds with the polymer material. The polymer material is a thermoplastic polymer for enclosing the graphene sheets. More specifically, the graphene sheets are aligned in parallel along the axis of the graphene composite fiber.

The polymer material comprises at least one of polyethylene, polypropylene, nylon, polyamide, polyurethane, polyacrylonitrile-butadiene-styrene, polyethylene terephthalate, polystyrene, artificial rubber and polyester. The first organic functional group comprises one of alkoxy group, carbonyl group, carboxyl group, acyloxy group, acylamino group, alkyleneoxy group and alkyleneoxy-carboxyl group. The second organic functional group comprises at least one of ethyl group, lipoepoxylalkyl group, styryl group, methylpropylacyloxy group, acrylyloxy group, lipoamino group, chloropropyl group, lipothiohydroxy group, liposulfido group, isocyanato group, lipourea group, lipocarboxyl group, lipohydroxyl group, cyclohexanyl group, phenyl group, lipoformyl group, acetyl group, benzoly group, amino group and carboxyl acid group.

Another object of the present invention is to provide a method for manufacturing graphene composite fibers, which comprises the steps of preparing graphene sheets, surface modifying, blending, forming raw particles and spinning.

Specifically, in the step of preparing graphene sheets, the graphene sheets are prepared, and each graphene sheet is formed of N graphene layers stacked, wherein N is one integer larger than 1 and less than 1,000.

The step of surface modifying is performed by using a surface modifying agent to modify the surface of the graphene sheet to form at least one modified layer so as to form the graphene sheets with modified surfaces. The surface modifying agent comprises a first organic functional group for forming chemical bond with the graphene layers, and a second organic functional group provided on the surface of the graphene sheet for bonding with a polymer material.

In the blending step, the graphene sheets with modified surfaces are added into the melted polymer material for blending such that the graphene sheets with modified surfaces and the polymer material are homogenously blended and mixed, and the second organic functional group forms chemical bond with the polymer material. The graphene sheets with modified surfaces are 1˜10% by weight of the graphene composite fiber.

The step of forming raw particles is performed by using a granulator to process the graphene sheets and the polymer material blended so as to form graphene-polymer composite raw particles. In the step of spinning, a plurality of graphene composite fibers are formed by spinning the graphene-polymer composite raw particles. More specifically, the graphene sheets are aligned along the axis of the graphene composite fiber by the shear force provided in spinning.

The graphene composite fiber of the present invention possesses excellent mechanical strength, thermal conductivity and electrical conductivity, and can be manufactured by use of traditional weaving method with simple processes so as to reduce the manufacturing cost, thereby replacing the high performance carbon fiber commonly used in the military, energy and entertainment industries.

### BRIEF DESCRIPTION OF THE DRAWINGS

The present invention can be understood in more detail by reading the subsequent detailed description in conjunction with the examples and references made to the accompanying drawings, wherein:

FIG. 1 is a view showing a graphene composite fiber according to the present invention;

FIG. 2 is a view locally magnifying the graphene sheets in FIG. 1; and

FIG. 3 is a flowchart showing a method for manufacturing graphene composite fiber according to the present invention.

### DETAILED DESCRIPTION OF THE PREFERRED EMBODIMENTS

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

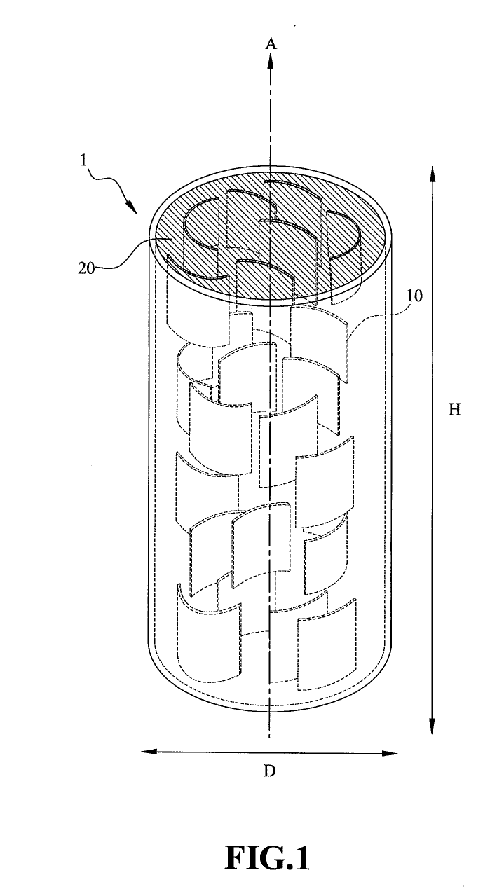

Please refer to FIG. 1. As shown in FIG. 1, the graphene composite fiber 1 according to the present invention generally comprises a plurality of graphene sheets 10 and a polymer material 20. Specifically, the graphene sheets 10 are aligned along the axis A of the graphene composite fiber 1. The graphene sheets 10 are 1˜10% by weight of the graphene composite fiber, and each graphene sheet 10 has a thickness within a range of 1 nm to 50 nm, a planar lateral dimension within a range of 1 μm to 100 μm, and a ratio of planar lateral dimension and the thickness within a range of 10 to 10,000. Moreover, the polymer material 20 fully encloses the graphene sheets 10. The graphene composite fiber 1 has an electrical conductivity within a range of 10⁻³ to 10² S/cm, a thermal conductivity greater than 5 W/mK, and a tensile strength larger than 100 MPa.

The graphene sheets 10 has a content of oxygen less than 3% by weight, a content of carbon larger than 95% by weight, and a specific surface area within a range of 20 to 750 m²/g. The polymer material 20 is preferably a thermoplastic polymer for enclosing the graphene sheets 10, and may comprise at least one of polyethylene, polypropylene, nylon, polyamide, polyurethane, polyacrylonitrile-butadiene-styrene, polyethylene terephthalate, polystyrene, artificial rubber and polyester.

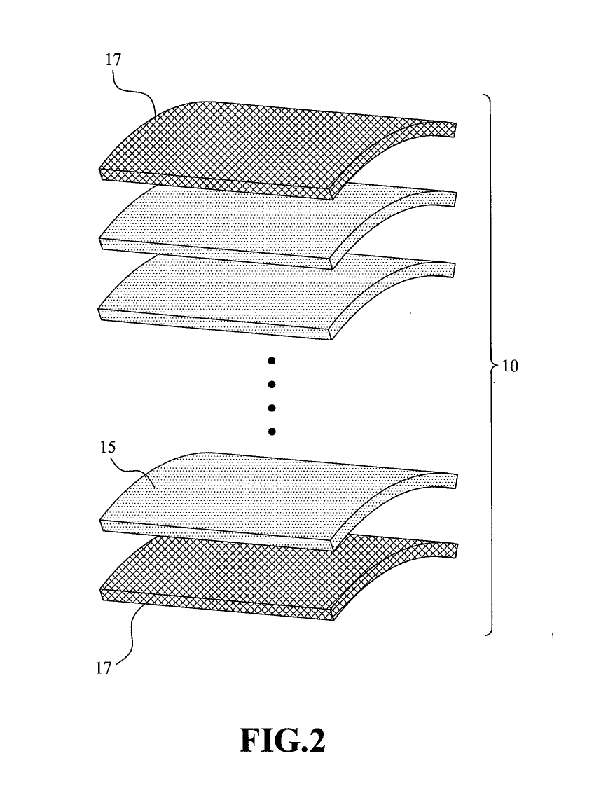

Refer to FIG. 2, a magnifying view for the graphene sheets in FIG. 1. As shown in FIG. 2, the graphene sheets 10 are substantially formed of graphene layers 15 stacked together, wherein N is one integer larger than 1 and less than 1,000. The graphene sheets 10 have a tap density within a range of 0.1 g/cm³ to 0.01 g/cm³, and each graphene sheet 10 further comprises at least one modified layer 17 on a surface of the graphene sheet 10. More specifically, the modified layer 17 comprises the first organic functional groups for forming chemical bonds with the graphene layers 15, and the second organic functional groups provided on the surface of the graphene sheet 10 so as to help form chemical bonds with the polymer material 20. Generally, the first organic functional group comprises one of alkoxy group, carbonyl group, carboxyl group, acyloxy group, acylamino group, alkyleneoxy group and alkyleneoxy-carboxyl group. The second organic functional group substantially comprises at least one of ethyl group, lipoepoxylalkyl group, styryl group, methylpropylacyloxy group, acrylyloxy group, lipoamino group, chloropropyl group, lipothiohydroxy group, liposulfido group, isocyanato group, lipourea group, lipocarboxyl group, lipohydroxyl group, cyclohexanyl group, phenyl group, lipoformyl group, acetyl group, benzoly group, amino group and carboxyl acid group.

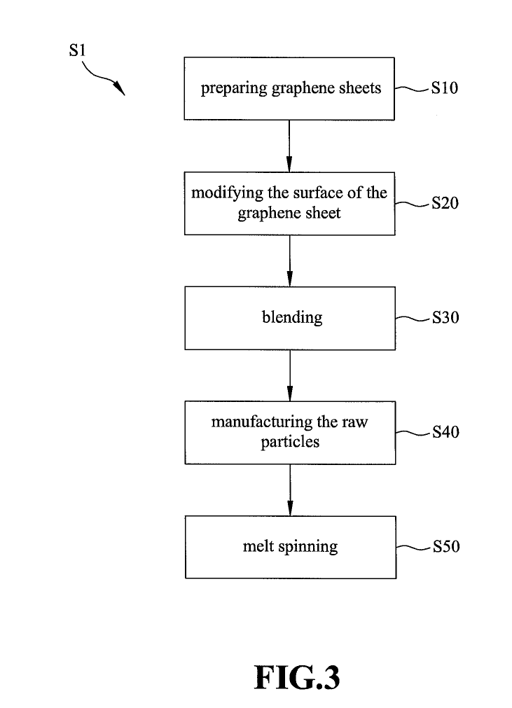

Further refer to FIG. 3 illustrating the flowchart of the method for manufacturing graphene composite fiber according to the present invention. As shown in FIG. 3, the method S1 of the present invention generally comprises the steps of preparing graphene sheets S10, surface modifying S20, blending S30, forming raw particles S40 and spinning S50.

Specifically, the graphene sheets are prepared in the step S10, and each graphene sheet is formed of N graphene layers stacked, wherein N is one integer larger than 1 and less than 1,000. The graphene sheet has a content of oxygen less than 3% by weight, a content of carbon larger than 95% by weight, and a specific surface area within a range of 20 to 750 m²/g. Additionally, the graphene sheets have a tap density within a range of 0.1 g/cm³ to 0.01 g/cm³. Each graphene sheet has a thickness within a range of 1 nm to 50 nm, a planar lateral dimension within a range of 1 μm to 100 μm, and a ratio of planar lateral dimension and the thickness within a range of 10 to 10,000.

Next, the step of surface modifying S20 is performed by using a surface modifying agent to modify the surface of the graphene sheet to form at least one modified layer. The surface modifying agent comprises the first organic functional group for forming chemical bonds with the graphene layers, and the second organic functional group provided on the surface of the graphene sheet for changing the surface properties of the graphene. For example, the first organic functional group comprises one of alkoxy group, carbonyl group, carboxyl group, acyloxy group, acylamino group, alkyleneoxy group and alkyleneoxy-carboxyl group, and the second organic functional group comprises at least one of ethyl group, lipoepoxylalkyl group, styryl group, methylpropylacyloxy group, acrylyloxy group, lipoamino group, chloropropyl group, lipothiohydroxy group, liposulfido group, isocyanato group, lipourea group, lipocarboxyl group, lip ohydroxyl group, cyclohexanyl group, phenyl group, lipoformyl group, acetyl group, benzoly group, amino group and carboxyl acid group.

In the blending step S30, the polymer material is melted and then added into the graphene sheets with modified surfaces in a blender, a kneader, a homogenizer or a mixer for homogenously blending and mixing. As a result, the second organic functional group on the surface of the graphene sheet forms chemical bonds with the polymer material. More specifically, the graphene sheets with modified surfaces are 1˜10% by weight of the graphene composite fiber. The blending step S30 is substantially performed by mechanical force to well mix the polymer material and the graphene sheets with modified surfaces. The polymer material in the kneader is deformed and broken to pieces by the shear force and tensile stress, and thus fully contacts the graphene sheets with modified surfaces. Further, the contact area for the polymer material and the graphene sheets is increased, thereby improving the homogeneousness of mixing.

The step of forming raw particles S40 is performed by using a granulator to process the graphene sheets and the polymer material blended so as to form graphene-polymer composite raw particles, which are available for the subsequent weaving processes. In the step of spinning S50, a plurality of graphene composite fibers are formed by the process of melt spinning or melt blowing, and the graphene sheets in the graphene composite fiber are aligned in parallel with the axis A of the graphene composite fiber by the resultant mechanical force.

Some illustrative examples below are used to explain the graphene composite fiber and the method for manufacturing the same according to the present invention. First, the step S10 is implemented by the following processes: pouring 10 g of natural graphite powder into 230 ml of sulfuric acid (H₂SO₄), slowly adding 30 g of potassium manganate (KMnO₄) with continuously stirring at a temperature below 20° C. in an ice bath, further stirring for at least 40 minutes at 35° C., slowly adding 460 ml of deionized water with stirring for at least 20 minutes at 35° C., adding 1.4 L of deionized water and 100 ml of hydrogen peroxide (H₂O₂) after the reaction completes, standing still for 24 hours, filtering and cleaning with 5% hydrochloric acid (HCl), and finally drying the resultant product in vacuum so as to obtain graphite oxide powder. Subsequently, the graphite oxide powder is placed in vacuum to instantly contact a heat source at 1100° C. for one minute so as to result in thermal peeling, and thus nano graphite sheet structure is obtained. Next, the nano graphite sheet structure is suspended in a high pressure solution, and imposed by shear force to form nano graphene sheet suspension. The suspension is processed by a sprayer to form fog drops, and the fog drops are then forced to contact hot air at 200° C. for fast drying so as to form dried graphene sheets, which are finally collected by a gas-solid separator.

The following illustrative experiments are use to describe the subsequent processing steps with various compositions and in different manners.

### [Illustrative Experiment 1]

In the step S20, epoxy resin is selected as the surface modifying agent. Epoxy resin is actually dissolved in an acetone solution and added with the graphene sheets by stirring mixing. The powder obtained after the process of filtering by vacuum extraction is then heated and dried in an oven to form the graphene sheets with modified surfaces. Next, the graphene sheets with modified surfaces are gradually and quantitatively added into thermoplastic nylon particles up to 2% by weight. The mixture is further placed in the kneader and processed in the step S30 to homogeneously mix and blend the graphene sheets with modified surfaces and thermoplastic nylon. The homogeneous mixture is processed by the granulator to form raw particles in the step S40. Finally, the raw particles are treated by the process of melt spinning in the step S50 to obtain the graphene composite fiber.

### [Illustrative Experiment 2]

In the step S20, coupling amino siloxane is selected as the surface modifying agent. The actual process comprises adding amino siloxane into a mixed solution of ethanol and water, then adding graphene sheets, stirring and mixing, filtering the powder from the mixture by vacuum extraction, heating and drying the powder in the oven to form the graphene sheets with modified surfaces. In the step S30, the graphene sheets with modified surfaces are gradually and quantitatively added into thermoplastic polystyrene particles up to 2% by weight. The mixture is processed by the kneader to well blend. The mixed graphene sheets with modified surfaces and the thermoplastic polystyrene particles are processed by the granulator to form raw particles in the step S40. The raw particles are treated by the melt spinning in the step S50 to obtain the graphene composite fiber.

### [Illustrative Experiment 3]

The graphene sheets with modified surfaces generated in Illustrative experiment 2 are added into a solution of vinyl alcohol. In the step S30, terephthalic acid is used to perform condensation polymerization with the graphene sheets with modified surfaces dissolve in the solution of vinyl alcohol, and the mixture is homogeneously blended by the kneader. Then, the granulator is used in the step S40 and finally, the graphene composite fiber is obtained by the melt spinning in the step S50.

### [Illustrative Experiment 4]

In the step S20, succinic anhydride and aluminum chioride are selected as the surface modifying agent. The actual process comprises adding N-methyl pyrollidone into succinic anhydride and aluminum chioride, mixing and heating, adding the graphene sheets after the reaction finishes, filtering the powder by vacuum extraction, and drying the powder in the oven to obtain the graphene sheets with modified surfaces. In the step S30, the graphene sheets with modified surfaces are gradually and quantitatively added into thermoplastic polyacrylonitrile-butadiene-styrene particles up to 5% by weight. The mixture is processed by the kneader to well blend and then processed by the granulator to form raw particles in the step S40. Finally, the raw particles are treated by the melt spinning in the step S50 to obtain the graphene composite fiber.

TABLE 1

| | Experiment 1 | Experiment 2 | Experiment 3 | Experiment 4 |
|---|---|---|---|---|
| electrical | 3 * 10⁻³ | 1 * 10⁻³ | 8 * 10⁻² | 2 * 10⁻¹ |
| conductivity | | | | |
| (S/cm) | | | | |
| tensile strength | 104 | 110 | 117 | 160 |
| (MPa) | | | | |

Table 1 lists the properties of the graphene composite fiber manufactured in the above illustrative experiments 1-4. As shown in Table 1, the electrical conductivity of the graphene composite fiber is 10⁻⁴ to 10² S/cm, and the tensile strength is larger than 100 MPa. Moreover, from the heat absorption and transmission curve through Infrared measurement and the thermal image analyzer for the graphene composite fiber illuminated with the 500 W halogen lamp for 10 minutes, it is found that the heat absorbed is dissipated to the environment at room temperature in 2 minutes, thereby implementing the cooling effect.

From the above-mentioned, one aspect of the present invention is that the current process of the traditional weaving industry can be directly used to manufacture the graphene composite fiber of the present invention, which possesses excellent mechanical strength, thermal conductivity and electrical conductivity. Furthermore, the whole manufacturing process of the graphene composite fiber is quite simple, thereby replacing the high performance carbon fiber commonly used in the of military, energy and entertainment industries.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A graphene composite fiber, comprising:
a plurality of graphene sheets being 1˜10% by weight of the graphene composite fiber, each graphene sheet formed of N graphene layers stacked, the graphene sheet comprising at least one modified layer on a surface of the graphene sheet, the modified layer comprising first organic functional groups for forming chemical bonds with the graphene layers and second organic functional groups; and
a polymer material being a thermoplastic polymer for enclosing the graphene sheets and forming chemical bonds with the second organic functional groups,
wherein N is one integer larger than 1 and less than 1,000, and the graphene sheets are aligned in parallel with an axis of the graphene composite fiber.

2. The graphene composite fiber as claimed in claim 1, wherein the graphene sheets have a tap density within a range of 0.1 g/cm³ to 0.01 g/cm³, and each graphene sheet has a thickness within a range of 1 nm to 50 nm, a planar lateral dimension within a range of 1 μm to 100 μm, a ratio of planar lateral dimension and the thickness within a range of 10 to 10,000, a content of oxygen less than 3% by weight, a content of carbon larger than 95% by weight, and a specific surface area within a range of 20 to 750 m²/g.

3. The graphene composite fiber as claimed in claim 1, wherein the polymer material comprises at least one of polyethylene, polypropylene, nylon, polyamide, polyurethane, polyacrylonitrile-butadiene-styrene, polyethylene terephthalate, polystyrene, artificial rubber and polyester.

4. The graphene composite fiber as claimed in claim 1, wherein the first organic functional group comprises one of alkoxy group, carbonyl group, carboxyl group, acyloxy group, acylamino group, alkyleneoxy group and alkyleneoxy-carboxyl group, and the second organic functional group comprises at least one of ethyl group, lipoepoxylalkyl group, styryl group, methylpropylacyloxy group, acrylyloxy group, lipoamino group, chloropropyl group, lipothiohydroxy group, liposulfido group, isocyanato group, lipourea group, lipocarboxyl group, lipohydroxyl group, cyclohexanyl group, phenyl group, lipoformyl group, acetyl group, benzoly group, amino group and carboxyl acid group.

5. The graphene composite fiber as claimed in claim 1, further having an electrical conductivity within a range of 10⁻⁴ to 10² S/cm, and a tensile strength larger than 100 MPa.

6. A method for manufacturing graphene composite fibers, comprising:
a step of preparing graphene sheets, each formed of N graphene layers stacked, N being one integer larger than 1 and less than 1,000;
a step of surface modifying by using a surface modifying agent to modify a surfaces of the graphene sheet to form at least one modified layer so as to form the graphene sheets with modified surfaces, the surface modifying agent comprising a first organic functional group for forming chemical bonds with the graphene layers and a second organic functional group provided on the surface of the graphene sheet;
a step of blending by adding the graphene sheets with modified surfaces into a polymer material melted for blending such that the graphene sheets with modified surfaces and the polymer material are blended, the second organic functional group forming chemical bonds with the polymer material, the graphene sheets with modified surfaces being 1˜10% by weight of the graphene composite fiber;
a step of forming raw particles by using a granulator to process the graphene sheets and the polymer material blended so as to form graphene-polymer composite raw particles; and
a step of spinning by spinning the graphene-polymer composite raw particles to form a plurality of graphene composite fibers.

7. The method as claimed in claim 6, wherein the graphene sheets have a tap density within a range of 0.1 g/cm³ to 0.01 g/cm³, and each graphene sheet has a thickness within a range of 1 nm to 50 nm, a planar lateral dimension within a range of 1 μm to 100 μm, a ratio of planar lateral dimension and the thickness within a range of 10 to 10,000, a content of oxygen less than 3% by weight, a content of carbon larger than 95% by weight, and a specific surface area within a range of 20 to 750 m²/g.

8. The method as claimed in claim 6, wherein the polymer material comprises at least one of polyethylene, polypropylene, nylon, polyamide, polyurethane, polyacrylonitrile-butadiene-styrene, polyethylene terephthalate, polystyrene, artificial rubber and polyester.

9. The method as claimed in claim 6, wherein the first organic functional group comprises one of alkoxy group, carbonyl group, carboxyl group, acyloxy group, acylamino group, alkyleneoxy group and alkyleneoxy-carboxyl group, and the second organic functional group comprises at least one of ethyl group, lipoepoxylalkyl group, styryl group, methylpropylacyloxy group, acrylyloxy group, lipoamino group, chloropropyl group, lipothiohydroxy group, liposulfido group, isocyanato group, lipourea group, lipocarboxyl group, lipohydroxyl group, cyclohexanyl group, phenyl group, lipoformyl group, acetyl group, benzoly group, amino group and carboxyl acid group.

10. The method as claimed in claim 6, wherein the step of blending is performed in a blender, a kneader, a homogenizer or a mixer, and the step of spinning is performed by melt spinning or melt blowing.
